(19) United States
(12) Patent Application Publication
(10) Pub. No.: US 2014/0056499 A1
(43) Pub. Date: Feb. 27, 2014

(54) APPARATUS AND METHOD FOR GENERATING IMAGE USING CORRECTION MODEL

(71) Applicant: Samsung Electronics Co., Ltd., Suwon-si (KR)

(72) Inventors: Byung-kwan PARK, Seoul (KR); Tae-yong SONG, Hwaseong-si (KR); Jae-mock YI, Hwaseong-si (KR)

(73) Assignee: Samsung Electronics Co., Ltd., Suwon-si (KR)

(21) Appl. No.: 13/888,407

(22) Filed: May 7, 2013

(30) Foreign Application Priority Data
Aug. 24, 2012 (KR) 10-2012-0093297
Sep. 18, 2012 (KR) 10-2012-0103619

(51) Int. Cl. G06T 5/00

(52) U.S. Cl. CPC G06T 5/003
USPC 382/131

(57) ABSTRACT

A method and apparatus for generating an image with a correction model are provided. The method of generating a correction model of a detector may involve: changing a location of a point source and obtaining a signal emitted from the point source; calculating at least one parameter representing a distribution characteristic of the obtained signal with respect to a plurality of projection directions at each of the changed locations; and generating the correction model of the detector based on the at least one parameter.

### CROSS-REFERENCE TO RELATED APPLICATIONS

This application claims the benefit of Korean Patent Application Nos. 10-2012-0093297 and 10-2012-0103619 filed on Aug. 24, 2012, and Sep. 18, 2012, respectively, in the Korean Intellectual Property Office, and of provisional U.S. Patent Application No. 61/643,428, filed on May 7, 2012, in the United States Patent and Trademark Office, the entire disclosure of all of which are incorporated herein by reference for all purposes.

### BACKGROUND

1. Field

The following description relates to methods and apparatuses for generating an image using a correction model, and to methods and apparatuses for generating a medical image such as a positron emission tomography (PET) image with a correction model.

2. Description of Related Art

A medical imaging device obtains visual images of the human body which are used in making diagnosis of medical conditions of a patient. Methods of capturing an image, for example a medical image, have actively been developed and are currently used in hospitals. Such methods are largely divided into methods of obtaining an anatomical image and methods of obtaining a physiological image. Examples of imaging technologies that provide detailed, high resolution anatomical images of the human body include magnetic resonance imaging (MRI) and computed tomography (CT). In CT and MRI, a 2-dimensional (2D) image of a cross-section of the human body or a 3D image of the human body or a part thereof is generated so as to show the accurate locations and shapes of organs in the human body. Such a 3D image of the human body may be obtained using several 2D high-resolution images. An example of a technology that produces physiological images is positron emission tomography (PET). PET can be used to diagnose a metabolic disorder by obtaining an image of the metabolic process that is going on inside the human body.

PET is an imaging technology in which special radioactive tracers are incorporated into components of the body that participate in a metabolic process. The radioactive tracers incorporated into the human body emit positrons. The tracers are often introduced into the human body via an intravenous injection or inhalation, and the locations of the tracers are obtained by using an external device that detects two gamma rays of 511 keV that are emitted in opposite directions to each other when the positrons emitted from the tracers combine with electrons. The distribution pattern of the tracers and a change in the distribution pattern with respect to time may be observed through a PET imaging apparatus such as a PET scanner.

### SUMMARY

In one general aspect, there is provided a method of generating a correction model of a detector, the method involving: changing a location of a point source in a detection space of the detector and obtaining a signal emitted from the point source for a period of time with respect to each of the changed locations of the point source; calculating at least one parameter representing a distribution characteristic of the obtained signal with respect to each of a plurality of projection directions at each of the changed locations of the point source from the obtained signal with respect to each of the changed locations of the point source; and generating the correction model of the detector based on the at least one parameter calculated with respect to each of the locations of the point source and each of the plurality of projection directions.

In the general aspect of the method, the location of the point source is changed according to a distance from a center of the detector to the point source.

In the general aspect of the method, the location of the point source is changed according to an angle from a line that crosses the center of the detector to the point source.

In the general aspect of the method, the angle is changed within a range that does not exceed an angle as determined from a geometric shape of the detector.

In the general aspect of the method, the calculating may involve: classifying the obtained signal with respect to each of the changed locations of the point source and with respect to each of the plurality of projection directions; and fitting a function to a distribution of the classified signals, in which the at least one parameter is a parameter of the fitted function.

In the general aspect of the method, the fitted function may be a Gaussian function.

In the general aspect of the method, the generating of the correction model may include: calculating at least one parameter with respect to inter-locations between each of the changed locations of the point source based on the at least one parameter calculated with respect to each of the locations of the point source and generating the correction model of the detector based on the calculated at least one parameter with respect the inter-locations and each of the locations of point source.

In the general aspect of the method, the generating of the correction model may include: generating the correction model of the detector by fitting a function corresponding to the correction model of the detector based on the at least one parameter calculated with respect to each of the locations of the point source and each of the plurality of projection directions.

In another general aspect, there is provided a method of generating an image, the method involving: changing a location of the point source in a detection space of a detector and obtaining a signal emitted from the point source for a period of time with respect to each of the changed locations of the point source; calculating at least one parameter representing a distribution characteristic of the obtained signal with respect to each of a plurality of projection directions at each of the changed locations of the point source from the obtained signal with respect to each of the changed locations of the point source; generating the correction model of the detector based on the at least one parameter calculated with respect to each of the locations of the point source and each of the plurality of projection directions; generating a first image based on a signal emitted from a tracer; and generating a second image by applying the generated correction model to the generated first image.

In the general aspect of the method, the generating of the second image may include using expectation maximization (EM) algorithm.

In another general aspect, there is provided an apparatus for generating a correction model of a detector, the apparatus including: a signal obtaining unit configured to change a location of a point source in a detection space of the detector and to obtain a signal emitted from the point source for a period of time with respect to each of the changed locations of the point source; a parameter calculation unit configured to calculate at least one parameter representing a distribution characteristic of the obtained signal with respect to each of a plurality of projection directions at each of the changed locations of the point source from the obtained signal with respect to each of the changed locations of the point source; and a correction model generation unit configured to generate the correction model of the detector based on the calculated at least one parameter calculated with respect to each of the locations of the point source and each of the plurality of projection directions.

In a general aspect of the apparatus, the location of the point source may be changed according to a distance from a center of the detector to the point source.

In a general aspect of the apparatus, the location of the point source may be changed according to an angle from a line that crosses the center of the detector to the point source.

In a general aspect of the apparatus, the angle may be changed within a range that does not exceed an angle as determined from a geometric shape of the detector.

The general aspect of the apparatus may further include a classification unit configured to classify the obtained signal with respect to each of the changed location of the point source for each of the plurality of projection directions; and a first fitting unit configured to fit a function to a distribution of the classified signals, in which the at least one parameter may be a parameter of the fitted function.

In a general aspect of the apparatus, the fitted function may be a Gaussian function.

In a general aspect of the apparatus, the correction model generation unit may be configured to calculate at least one other parameter with respect to inter-locations between each of the changed locations of the point source based on the at least one parameter calculated with respect to each of the locations of the point source and generates the correction model of the detector based on the calculated at least one parameter with respect the inter-locations and each of the locations of the point source.

In a general aspect of the apparatus, the correction model generation unit may be configured to generate the correction model of the detector by fitting a function corresponding to the correction model of the detector based on the at least one parameter calculated with respect to each of the locations of the point source and each of the plurality of projection directions.

In another general aspect, there is provided an apparatus for generating an image, the apparatus including: a signal obtaining unit configured to change a location of a point source in a detection space of a detector and to obtain a signal emitted from the point source for a period of time with respect to each of the changed locations of the point source; a parameter calculation unit configured to calculate at least one parameter representing a distribution characteristic of the obtained signal with respect to each of a plurality of projection directions at each of the changed locations of the point source from the obtained signal with respect to each of the changed locations of the point source; a correction model generation unit configured to generate the correction model of the detector based on the at least one parameter calculated with respect to each of the locations of the point source and each of the plurality of projection directions; a first image generation unit configured to generate a first image based on a signal emitted from a tracer; and a second image generation unit configured to generate a second image by applying the generated correction model to the first image.

In a general aspect of the apparatus, the second image generation unit may be configured to use expectation maximization (EM) algorithm.

In yet another general aspect, there is provided a non-transitory computer-readable storage medium having stored thereon a program, which when executed by a computer, performs the above-described methods.

Other features and aspects may be apparent from the following detailed description, the drawings, and the claims.

### BRIEF DESCRIPTION OF THE DRAWINGS

FIG. 1 is a diagram illustrating an example of an apparatus for generating an image.

FIG. 2 is a diagram illustrating an example of line of response (LOR) data.

FIG. 3 is a diagram illustrating an example of two gamma rays emitted from a tracer that do not form a straight line.

FIG. 4 is a block diagram illustrating an example of a blur model generating apparatus that generates a blur model of a positron emission tomography (PET) detector.

FIG. 5 is a diagram illustrating a structure of a detector illustrated in FIG. 1.

FIG. 6 is a diagram illustrating an example of a method of changing a location of a point source in a control unit of FIG. 4.

FIG. 7 is a diagram illustrating an example of a method of calculating a parameter in a parameter calculation unit illustrated in FIG. 4.

FIG. 8 illustrates examples of graphs depicting parameters calculated by the parameter calculation unit illustrated in FIG. 4.

FIG. 9 illustrates an example of a process of generating a blur model of a detector with parameters calculated by a parameter calculation unit.

FIG. 10 is a block diagram illustrating components of an example of a computer that is used to implement an apparatus for generating an image.

FIG. 11 is a flowchart illustrating an example of a blur model generating method.

FIG. 12 is a flowchart illustrating an example of an image generating method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Described below are examples of methods of and apparatuses for generating a high resolution image by using a correction model in positron emission tomography (PET). Also described below are examples of computer-readable storage media having stored thereon a program, which when executed by a computer, performs such methods.

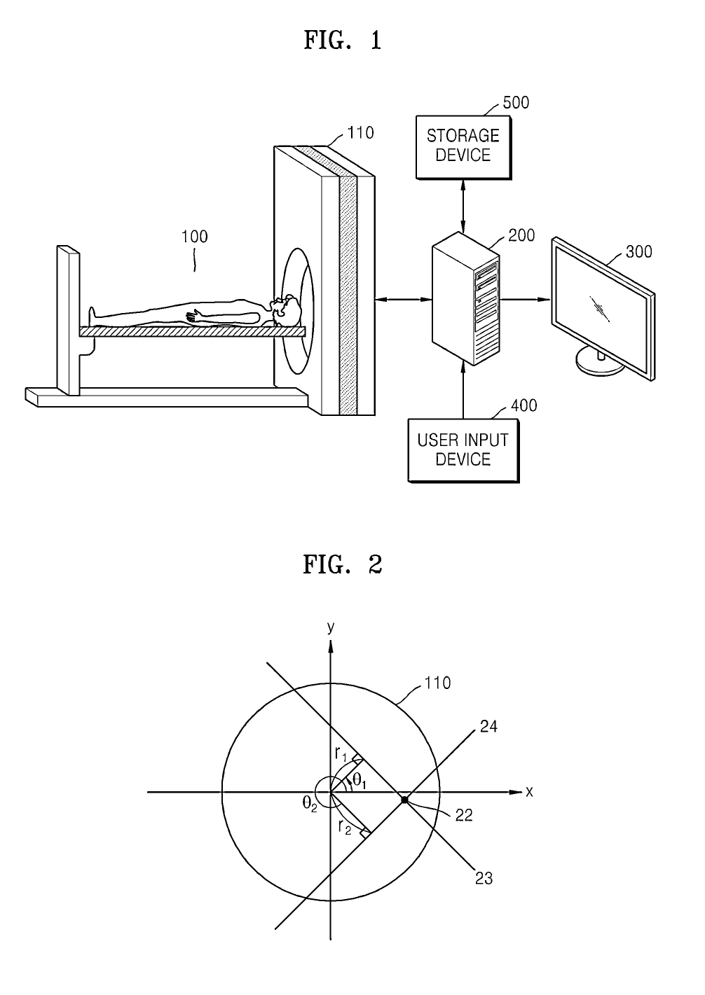

FIG. 1 is a diagram illustrating an example of an apparatus for generating an image. FIG. 1 illustrates an overall system for generating an image of a cross-section of the body of a patient. Referring to FIG. 1, the apparatus includes a signal detection device 100, a computer 200, a display device 300, and a user input device 400.

The apparatus for generating the image of FIG. 1 may be used to generate an image of a cross-section of the body of a patient as well as generate a correction model of a detector 110 that is used to generate the image. The obtained image may be a physiological image of the body. The correction model of the detector 110 is a model used to generate a high resolution image or to correct a low resolution image that is obtained by the detector 110 into a high resolution image. An example of a correction model is a blur model used to correct the spreading or blurring that may be present in an image. An apparatus for generating an image, such as the example illustrated in FIG. 1, may be used to generate an image of a cross-section of the body of a patient as well as generate a blur model of a detector 110 that may be used to refine the obtained image.

Examples of a method of generating an image of the cross-section of a body of a patient and a method of generating a blur model of a detector 110 will now be described below. Blurring refers to a degree of spreading of a point or an image. For example, in an example in which a detector 110 is used to estimate the locations of positron emission materials located in a detection space of the detector 110, the degree of blurring represents how a distribution of the estimated locations spreads or is smudged with respect to the actual locations of the positron emission materials. In this regard, a point spread function (PSF) may be used to characterize the blurring.

Furthermore, the blur model of the detector 110 may be generated by placing a positron emission material in each location coordinates in a detection space of the detector 110, obtaining a signal from the positron emission material, generating a PSF with respect to each of the location coordinates, summing these PSFs, and generating a PSF model with respect to the whole detection space of the detector 110.

In an example, the apparatus for generating the image of FIG. 1 may be used to generate a physiological image of a cross-section of the body of a patient. The signal detection device 100 illustrated in FIG. 1 may detect a signal emitted by a tracer that has been injected into a target—such as the body of a patient. With respect to the description that follows, the term tracer is used to indicate a positron emission material. For example, the signal detection device 100 detects two gamma rays emitted when a positron emitted from a tracer that has been injected into a body of the patient combines with an electron and annihilates. The two gamma rays travel in opposite directions, forming a substantially straight line. The paths traveled by the gamma rays define the line of response. Information regarding the paths may be detected and collected by the detector 110. The signal detection device 100 transmits line of response (LOR) data regarding the detected gamma rays to the computer 200.

In an example, the apparatus for generating the image of FIG. 1 is used to generate a blur model of the detector 110. The signal detection device 100 illustrated in FIG. 1 may detect a signal emitted by the tracer that has been injected into a target. For example, the signal detection device 100 may detect two gamma rays emitted when a positron emitted from the tracer that has been injected into the body of a patient combines with an electron. The signal detection device 100 may transmit the LOR data regarding the detected gamma rays to the computer 200.

In an example in which the apparatus for generating the image illustrated in FIG. 1 is used to generate a blur model of a detector 110, the signal detection device 100 may detect two gamma rays emitted when a positron emitted from point sources located inside the detector 110 combines with an electron. The signal detection device 100 may transmit the LOR data regarding the detected gamma rays to the computer 200.

In this regard, the LOR data is data representing a location of a straight line in a space through which the gamma rays travel. The interpretation of the LOR data will now be described below with reference to FIG. 2.

FIG. 2 is a diagram illustrating an example of LOR data. Referring to FIG. 2, a tracer 22 that is located in the detector 110 emits two gamma rays when positrons emitted from the tracer 22 collide with electrons. The two gamma rays are emitted in opposite directions along a straight line. The paths traveled by the two gamma rays are substantially at 180° from each other. FIG. 2 illustrates two straight lines 23 and 24, which illustrate the trajectories of two sets of gamma ray pairs that traveled in opposite directions from their corresponding pairs. Referring to the straight line 23, when a perpendicular line is drawn to the straight line 23 starting from an origin of the detecting space of the detector 110, a distance from the center of the detector 110 to the straight line 23 is r1 and an angle between the perpendicular line on the straight line 23 and an x-axis of the detector 110 is θ1. Thus, the LOR corresponding to the straight line 23 is (r1, θ1). Similarly, referring to the straight line 24, when a line is drawn perpendicular to the straight line 24 starting from the origin in the detector 110, a distance from the center of the detector 110 to the straight line 24 is r2 and an angle between the line drawn perpendicular to the straight line 24 and the x-axis of the detector 110 is θ2. Thus, the LOR corresponding to the straight line 24 is (r2, θ2). As described above, when two or more pieces of LOR data are obtained, a location of a tracer 22 may be determined from the LOR data. Accordingly, the signal detection device 100 may transmit LOR data about the detected gamma rays to the computer 200, and the computer 200 may finally determine a location of a tracer from the LOR data.

Referring to FIG. 1, the computer 200 generates an image of the target by using data obtained from the signal detection device 100. In an example in which the apparatus for generating the image of FIG. 1 is used to generate a physiological image of a cross-section of the body, the computer 200 may generate the image by using the data obtained from the signal detection device 100. In an example in which the apparatus for generating the image of FIG. 1 is used to generate a blur model of the detector 110, the computer 200 generates the blur model of the detector 110 by using the data obtained from the signal detection device 100.

The display device 300 may display the generated image of the cross-section of the body of a patient or the generated blur model of the detector 110 on a display panel.

The user may input information required for operations of the computer 200 through the user input device 400. For example, the user may start and stop the operations of the computer 20 by using the user input device 400.

In this regard, with respect to the computer 200 that generates an image of the target, image quality may be influenced by a spatial resolution of the detector 110. Factors that may deteriorate the spatial resolution of a PET detector include an angle fluctuation of a gamma ray, a range of a positron, a geometric shape of a detector, and the like.

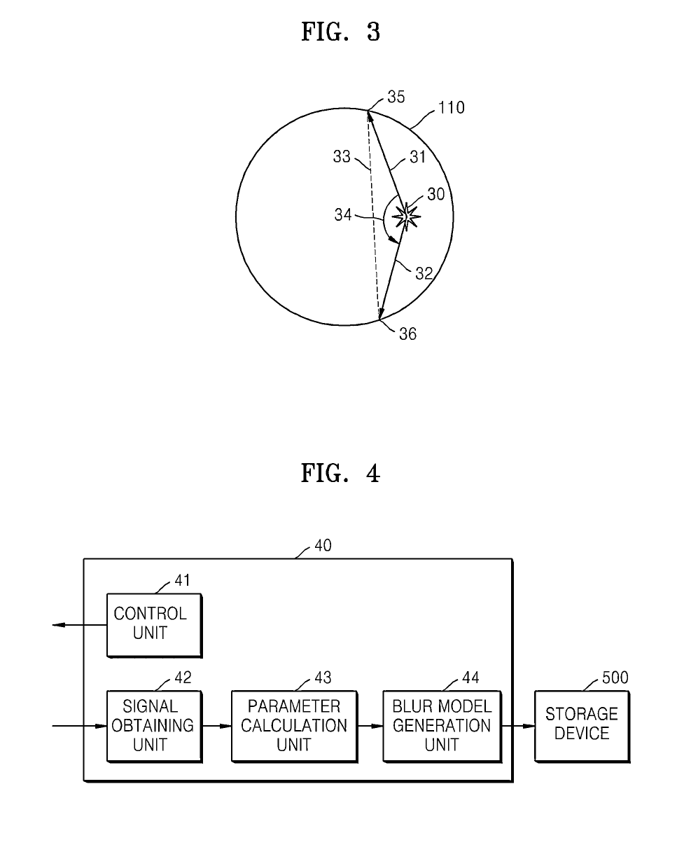

For example, the resolution of a PET image deteriorates if two gamma rays emitted from a tracer do not precisely form 180 degrees but rather form an angle that is slightly greater or less than 180 degrees. This angle deviation is referred to as an angle fluctuation of the gamma ray. This example will now be described below with reference to FIG. 3.

FIG. 3 is a diagram for describing an example of two gamma rays 31 and 32 emitted from a tracer 30 that do not form a straight line.

In FIG. 3, the two gamma rays 31 and 32 emitted from the tracer 30 do not precisely form 180 degrees. Rather, the two gamma rays 31 and 32 form an angle 34 slightly greater or less than 180 degrees. In this regard, the detector 110 recognizes locations 35 and 36 at which the gamma rays 31 and 32 are detected, and estimates that the tracer 30 is located on a straight line 33 that connects the locations 35 and 36. However, the tracer 30 does not actually exist on the straight line 33. The resolution of a PET image may remarkably deteriorate due to the above issue as the diameter of the detector 110 increases.

With respect to the range of a positron, the resolution of the PET image deteriorates based on a distance that the positron moves after being emitted from a tracer before colliding with an electron, releasing the gamma rays. For example, the positron loses energy while moving a short distance after being emitted from the tracer. Thereafter, the positron combines with an electron and annihilates, releasing a pair of gamma rays having energy of 511 keV in opposite directions. The distance that the positron travels before releasing energy is referred to as a positron range. Because the positron emits gamma rays after moving away from the tracer by the position range, a location of the tracer and a location at which the gamma rays are emitted are not the same. Thus, determining the location of the tracer based on the calculated location at which the gamma rays are emitted may result in an error. The deterioration of the resolution of PET due to the error is referred to as a positron range effect. In general, the greater the energy of a positron, the greater its positron range and the lower the resolution of a corresponding PET image.

With respect to a geometric shape of the detector 110, due to a parallax error for each coordinate in the detecting space of the detector 110 with a given geometric shape of the detector 110, the farther each of the coordinate is from the center of the detector 110 the more the resolution of the PET image deteriorates. For example, a plurality of detection elements may be closely arranged on a surface of the detector 110. In an example in which each of the detection elements have rectangular shapes that are longer in a depth direction, if a gamma ray is inclinedly incident to the detection elements, the gamma ray is simultaneously detected in several adjacent detection elements rather than being detected in just one detection elements. Thus, in this example, it is difficult to estimate a precise location of a tracer, and the resolution of the PET deteriorates.

The resolution of the PET deteriorates due to various factors other than the above three factors. Some of these factors occur stochastically. Thus, there exists a limit as to how much the resolution may be enhanced through a technical or mechanical enhancement method. Thus, to further improve resolution, a method of generating stochastic blur information to enhance the image quality is proposed. The method may involve generating the blur information corresponding to each of a plurality of voxels of the detector 110 in a form of a PSF, generating a blur model with respect to the detector 110 from the PSF of each of the voxels, inversely applying the blur model of the detector 110 to a low resolution PET image captured by using the detector 110, and generating a high resolution image from which blur is eliminated.

According to another example, the apparatus for generating an image illustrated in FIG. 1 may be used in a method to generate a physiological image of a cross-section of the body of a patient as well as to generate a blur model of a detector 110. A method of generating the blur model of the detector 110 will now be described with reference to FIGS. 4 through 6.

FIG. 4 is a block diagram of an example of a blur model generation device 40 that generates a blur model with respect to a PET detector. In this example, the computer 200 of FIG. 1 may be used as the blur model generation device 40 illustrated in FIG. 4. Referring to FIG. 4, the blur model generation device 40 includes a control unit 41, a signal obtaining unit 42, a parameter calculation unit 43, and a blur model generation unit 44. The control unit 41, the signal obtaining unit 42, the parameter calculation unit 43, and the blur model generation unit 44 may include one or more processors. The storage device 500 may also be implemented as a component of the computer 200. However, in other examples, the storage device 500 may be implemented external to the computer 200.

The control unit 41 may control the detector 110 or a point source located in a detection space of the detector 110 in order to change a location of the point source in the detection space of the detector 110.

For example, the control unit 41 may control the detector 110 or the point source in such a way that a distance from the center of the detector 110 to the point source increases at a predetermined distance interval. To this end, the control unit 41 may control the detector 110 or the point source in such a way that the distance from the center of the detector 110 to the point source increases at a predetermined distance interval while adjusting an angle from a predetermined straight line that crosses the center of the detector 110 to the point source.

In another example, the control unit 41 may control the detector 110 or the point source in such a way that the angle from the predetermined straight line that crosses the center of the detector 110 to the point source increases at a predetermined angle interval. For example, the control unit 41 may control the detector 110 or the point source in such a way that the angle from the predetermined straight line that crosses the center of the detector 110 to the point source increases at the predetermined angle interval while adjusting the distance from the center of the detector 110 to each of the point sources.

In addition, to obtain signals with respect to various locations of the point source in the detection space of the detector 110, the control unit 41 may change the location of the point source by using a variety of methods known to those skilled in the art.

The signal obtaining unit 42 obtains a signal emitted from the point source according to each of their locations during a predetermined period of time that the control unit 41 changes the location of the point source in the detection space of the detector 110. The point source indicates a positron emission material. When a positron emitted from the point source combines with an electron, the positron annihilates and releases energy in the form of gamma rays. That is, the signal obtaining unit 42 obtains a gamma ray signal emitted when the positron emitted from the point source combines with an electron according to each location in the detection space of the detector 110. The information regarding the detected gamma ray signals is transmitted to the parameter calculation unit 43.

However, it is inefficient in terms of processing time or memory usage to generate a PSF from a signal detected with respect to all locations in the detection space of the detector 110 as the control unit 41 changes the location of the point source and the signal obtaining unit 42 obtains the signal according to each locations. Accordingly, a method of calculating a PSF by placing the point source only in some locations in the detection space of the detector 110 and generating the blur model of the detector 110 is proposed.

For example, assuming that the detector 110 is perfectly circular, PSFs with respect to the locations having the same distance from the center of the detector 110 are diagonal to each other. In addition, PSFs with respect to other locations may be estimated based on a PSF with respect to one location. The blur model generation device 40 may generate a PSF for locations on a specific straight line that crosses the center of the detector 110 by using a PSF obtained with respect to inter-locations on another straight line, and subsequently generate the blur model with respect to the whole detector 110 by using the generated PSF.

In this example, during the predetermined period of time, the control unit 41 may change the location of the point source in such a way that the distance from the center of the detector 110 to the point source at the predetermined distance interval is adjusted, and the signal obtaining unit 42 may obtain the signal emitted from the point source according to each of their respective locations during the predetermined period of time. For example, during the predetermined period of time, the control unit 41 may change the location of the point source by varying the distance from the center of the detector 110 to the point source while adjusting the angle from the predetermined straight line that crosses the center of the detector 110 to the point source. The signal obtaining unit 42 may obtain the signal emitted from the point sources according to each of their respective locations.

In other words, during the predetermined period of time, the control unit 41 may change the location of the point source on the predetermined straight line that crosses the center of the detector 110, and the signal obtaining unit 42 may obtain the signal emitted from the point source according to each of their respective locations on the predetermined straight line.

Accordingly, the blur model generation device 40 may generate the blur model of the whole detector 110 from the signal obtained from the point source according to each of their respective locations on the predetermined straight line.

However, since the detector 110 is not actually perfectly circular, the PSF generated according to the above assumption results in an error. Thus, the resolution of an image generated by applying the PSF may further deteriorate.

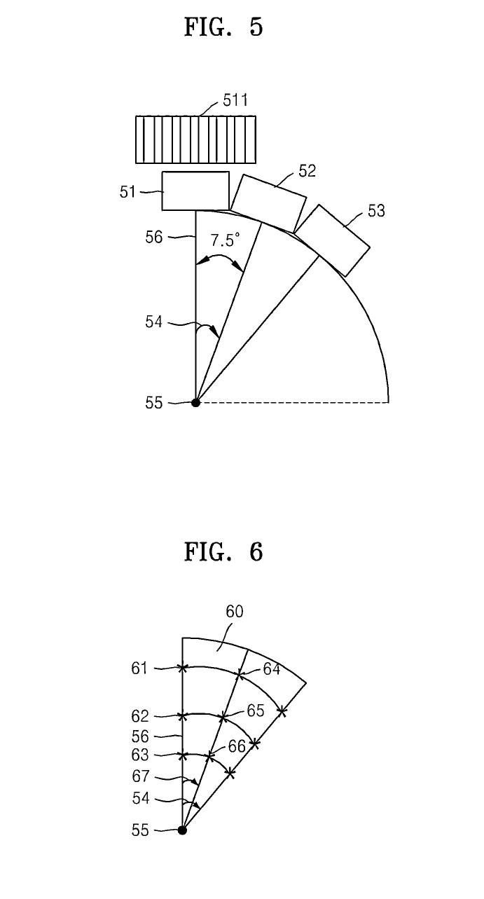

Therefore, recognizing that the detector 110 is not perfectly circular, the control unit 41 may change the location of the point source in consideration of the angle from the predetermined straight line that crosses the center of the detector 110 to the point source, and the signal obtaining unit 42 may obtain the signal emitted from the point source according to each of their locations during the predetermined period of time. This example will be described with reference to FIG. 5 below.

FIG. 5 illustrates a part of the structure of a detector 110. Referring to FIG. 5, a plurality of detection element blocks 51, 52, and 53 are arranged adjacent to each other on a surface of the detector 110. Additionally, each of the detection element blocks 51, 52, and 53 may include a plurality of detection elements 511. The number of detection elements and the number of detection element blocks present in a detector 110 may be determined in various ways according to circumstances in which the detector 110 is implemented.

Referring to the partial structure of the detector 110 illustrated in FIG. 5, the detection element blocks 51, 52, and 53 are arranged at a predetermined angle 54 from each other, and the detection element blocks 51, 52, and 53 do not have a curved inner surface; rather, the detection element blocks form a polygonal cross-section inside the detector 110. The arrangement of the detection elements 511 inside the detector 110 is not perfectly circular.

Therefore, the signal obtaining unit 42 obtains the signal emitted from the point source according to each of its respective locations during the predetermined period of time by changing the location of point source according to the various angles from the predetermined straight lines that cross the center of the detector 110 as well as the distance from the center of the detector 110 to the point source.

However, the method of calculating a PSF with respect to some locations in the detection space of the detector 110 and generating the blur model of the detector 110 is also proposed. For example, assuming that the detector 110 has a polygonal arrangement of detection elements 511, PSFs with respect to a plurality of locations having the same distance from the center of the detector 110 and that are at an angle corresponding to a multiple of the angle 54 from the predetermined straight line 56 that crosses the center of the detector 110 are diagonal to each other. Thus, in such an example, PSFs with respect to other locations may be estimated from a PSF with respect to one location.

To this end, the control unit 41 may change the location of the point source within a range of a partial area of the detector 110. For example, the control unit 41 may change the location of the point source within a range as long the angle from the predetermined straight line that crosses the center of the detector 110 to point source does not exceed a predetermined angle as determined from a geometric shape of the detector 110.

For example, the control unit 41 may change the location of point source within a range as long as the angle from a predetermined straight line 56 that crosses the center of the detector 110 to point source does not exceed the angle 54 between the detection element blocks 51, 52, and 53 in consideration of the geometric shape of the detector 110. This example will be described further with reference to FIG. 6 below.

FIG. 6 illustrates an example of a way of changing a location of the point source in the control unit 41 of FIG. 4. More specifically, FIG. 6 describes an example of changing the location of point source within a range as long as an angle from the predetermined straight line 56 that crosses the center of the detector 110 to the point source does not exceed the angle 54 between the detection element blocks 51, 52, and 53 in consideration of the geometric structure of the detector 110.

As described above with reference to FIG. 5, the detection element blocks 51, 52, and 53 are arranged away from each other by the predetermined angle 54 and do not have curved inner surfaces. Thus, the detector 110 has a polygonal cross-sectional shape, and is not perfectly circular in shape.

In consideration of the structure of the detector 110 with reference to FIG. 5, it may be assumed that a PSF with respect to an area (hereinafter referred to as a unit area) of a triangle formed between an inner surface of the detection element block 51 and the center of the detector 110 is diagonal to a PSF with respect to an area of a triangle formed between an inner surface of the detection element blocks 52 and 53 and the center of the detector 110.

Such a unit area is not necessarily limited to the triangular areas formed between the detection element blocks 51, 52, and 53 and the inner surface of the detector 110. Such a unit area may refer to any areas formed between the straight line 56 that crosses the center of the detector 110 and another straight line position at an angle 54 as defined by the detection element blocks 51, 52, and 53.

Alternatively, the unit area may refer to any areas formed between the straight line that crosses the center of the detector 110 and a straight line tilted away by an angle having a value that is a multiple of the angle 54 as defined by the arrangement of the detection element blocks 51, 52, and 53 from the straight line that crosses the center of the detector 110.

Referring to FIG. 6, the control unit 41 may change the location of the point source within a unit area 60, and the signal obtaining unit 42 may obtain the signal emitted from the point source according to each location during the predetermined period of time.

For example, the control unit 41 may change the location of the point source by varying the angle from the predetermined straight line 56 that crosses the center of the detector 110 to the point source within the unit area 60. The control unit 41 may repeat a process of varying the distance from the center of the detector 110 to the point source with respect to each of the varied angles. The signal obtaining unit 42 may obtain the signal emitted from the point source according to their respective locations during a predetermined period of time.

In the event that an angle from the predetermined straight line 56 that crosses the center of the detector 110 to the point source is 0 degree, locations 61 through 63 of FIG. 6 illustrate examples of possible locations of the point source as determined by repeating the process of varying the distance from the center of the detector 110 to the point source.

In the event that the angle from the predetermined straight line 56 that crosses the center of the detector 110 to the point source is a predetermined angle 67, locations 64 through 66 of FIG. 6 illustrate examples of possible locations of the point source as determined by repeating the process of varying the distance from the center of the detector 110 to the point source.

Accordingly, the blur model generation device 40 may generate a blur model of the whole detector 110 from a signal detected with respect to the area 60.

Referring to FIG. 2, the parameter calculation unit 43 may obtain a signal from the signal obtaining unit 42 with respect to each of the locations of the point source and calculates at least one parameter representing a distribution characteristic of the signal obtained with respect to each of a plurality of projection directions from the signal obtained with respect to each of the locations of the point source.

For example, the parameter calculation unit 43 generates a PSF representing a location distribution of the point source estimated from the signal obtained by the signal obtaining unit 42, and calculates at least one parameter representing a PSF characteristic with respect to each of a plurality of projection directions from the generated PSF with respect to each of the locations of the point source.

In this regard, a parameter may be a single parameter or a parameter group including a plurality of parameters. In the event that a plurality of parameters are used, the parameter calculation unit 43 may calculate a parameter group corresponding to each of the locations of the point source and each of the plurality of projection directions.

An example of a parameter representing a distribution characteristic of the signal obtained with respect to each of the projection directions and at each of the locations of the point source will now be described. For example, assuming that a point source is placed at a predetermined first location, a location of the point source as estimated from signals obtained with respect to the predetermined first location may be different from the predetermined first location as well as the predetermined first location itself. In other words, the estimated location may be another location in the vicinity of the predetermined first location. In this regard, a distribution of the estimated location of the point source may be expressed in a 3D graph indicating a probability that each location in the detector 110 is likely to be the actual location of the point source. Such a graph may be regarded as a PSF with respect to the first location.

In this regard, the above 3D graph may be projected in a plurality of directions and converted into 2D graphs with respect to each of the projection directions. Such 2D graphs represent a degree of spread of a 3D PSF with respect to each of the projection directions.

According to various examples in which the above-described methods may be applied, the parameter calculation unit 43 may convert a 3D graph indicating a PSF at one location into 2D graphs with respect to a plurality of projection directions and calculate a parameter capable of expressing a graph with respect to each of the converted 2D graphs.

Furthermore, the parameter calculation unit 43 may generate a 3D graph including a first axis indicating spatial coordinates in the detector 110, a second axis indicating a projection direction in each of spatial coordinates, and a third axis indicating a parameter value corresponding to the projection direction in each of the spatial coordinates.

The parameter calculation unit 43 may calculate a parameter corresponding to each of a plurality of projection directions at each location of the point source by repeating, with respect to each of the locations of the point source, a process of calculating the parameter corresponding to each of the plurality of projection directions with respect to each of the locations of the point source.

In an example of a method of calculating the parameter, the parameter calculation unit 43 may calculate a parameter indicating stochastic distribution of the locations of the point source with respect to each location in the detector 110 for each of the projection directions. To this end, the parameter calculation unit 43 may classify a signal obtained with respect to each locations within the detector 110 for each of the projection directions, fit the classified signals for each of projection directions to a predetermined function, and calculate a parameter with respect to the fitted function.

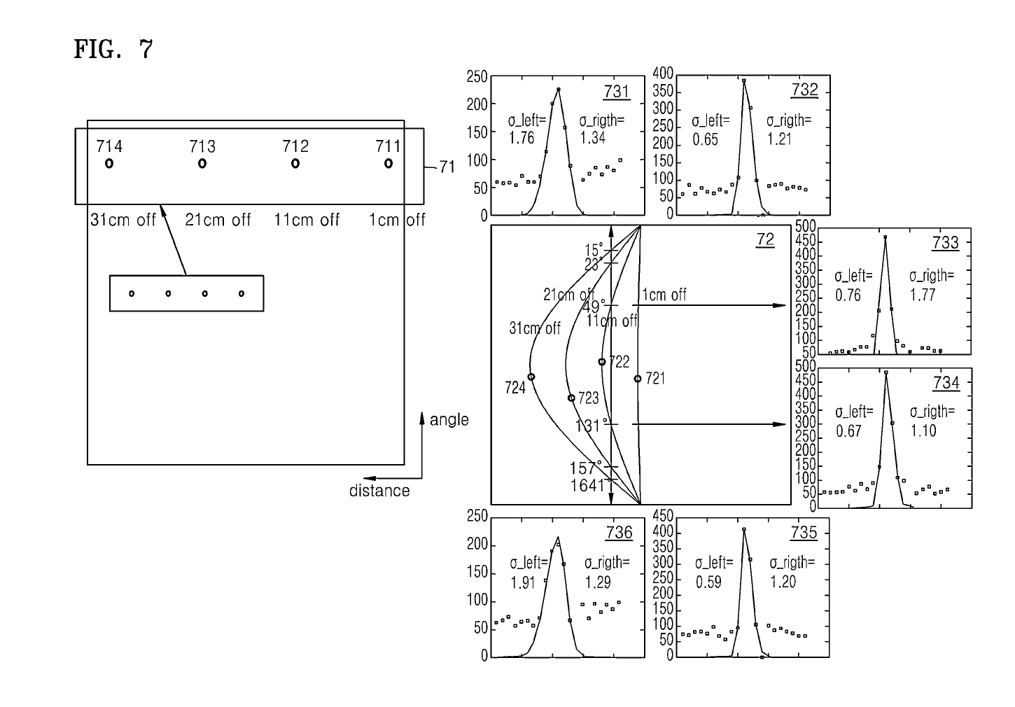

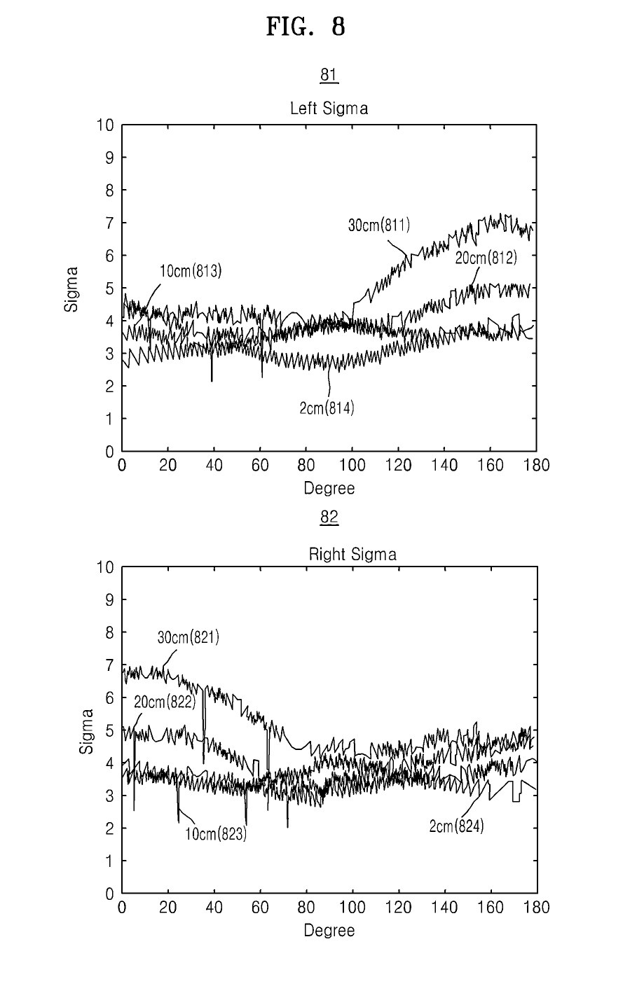

In this regard, the predetermined function may be a specific function indicating a probability distribution. For example, if the predetermined function is a Gaussian function, a parameter indicating blur information of each location may be one of μ, σ, etc. used as parameters of the Gaussian function. Thus, the parameter may be a parameter group including a single parameter or a plurality of parameters. Accordingly, the parameter calculation unit 43 may calculate the parameter group corresponding to each location of the point source and each of the projection directions. This example will be further described with reference to FIGS. 7 and 8 below.

FIG. 7 illustrates an example of a method for calculating a parameter in the parameter calculation unit 43 illustrated in FIG. 4. Referring to FIG. 7, a graph 71 illustrates an angle of 0 degree from a predetermined straight line that crosses the center of the detector 110 to each of the locations. The distributions 711, 712, 713, and 714 with respect to locations of point source are at distances n, n+a, n+a+b, and n+a+b+c, respectively, from the center of the detector 110 to the point source. In this regard, the distribution is a distribution of the locations of point source as estimated from a signal detected with respect to a location of a point source, wherein n denotes a distance value that is a natural number greater than 0, and a, b, and c denote optional constants. For instance, if a, b, and c have the same value, distances from the center of the detector 110 to point sources are determined to be equally increased, whereas if a, b, and c have different values, distances from the center of the detector 110 to point source may be determined to be unequally increased.

For example, if n is 1, and a=b=c=10, distances from the center of the detector 110 to point sources may be 1, 11, 21, and 31. This is merely an example of setting distances from the center of the detector 110 to point sources, and the present disclosure is not limited thereto. Various other examples may be used to set the locations of the point sources.

A graph 72 illustrates a distribution of each location in a sinogram. Distributions 711, 712, 713, and 714 sequentially correspond to sinograms 721, 722, 723, and 724. A vertical axis of each of the sinograms 721, 722, 723, and 724 represents an angle to which each of the distributions 711, 712, 713, and 714 is projected, and a horizontal axis thereof is a parameterized degree of blur distribution at each of the projection angles.

In the example of the distributions 724 illustrated in FIG. 7, the distribution 714 shows a distribution of a location of the point source estimated from a signal detected from a point source having a location that is a distance of 31 cm from the center of the detector 110 and an angle of 0 degree from a predetermined straight line that crosses the center of the detector 110 to the point sources. Although the location of the point source is fixed, the distribution 714 spreads out due to a factor such as a spatial resolution of PET and is blurred.

The parameter calculation unit 43 calculates a parameter by projecting the distribution 714 in various directions and fitting the projected distribution 714 to a probability function. If the probability function is a Gaussian function, p, a, etc. may be used as parameters as described above.

Graphs 731 through 736 show examples of projecting a distribution of a specific location in a specific direction and fitting the distribution to a probability function and parameters with respect to the examples. Graph 731 illustrates an example of projecting the distribution 714 at an angle of 15 degrees and fitting the distribution 714 to the Gaussian function. Graph 732 illustrates an example of projecting the distribution 713 at an angle of 23 degrees and fitting the distribution 713 to the Gaussian function. Graph 733 illustrates an example of projecting the distribution 712 at an angle of 49 degrees and fitting the distribution 712 to the Gaussian function. Graph 734 illustrates an example of projecting the distribution 712 at an angle of 131 degrees and fitting the distribution 712 to the Gaussian function. Graph 735 illustrates an example of projecting the distribution 713 at an angle of 157 degrees and fitting the distribution 713 to the Gaussian function. Graph 736 illustrates an example of projecting the distribution 714 at an angle of 164 degrees and fitting the distribution 714 to the Gaussian function.

Although the graphs 731 through 736 express only the parameter σ, they are provided only as examples, and the parameter μ or amplitude information representing the Gaussian function may be also calculated.

In the PET, a signal obtained from a point source is in the LOR format, and the LOR data contains information regarding the distance of a point source from the center of the detector 110 on a corresponding straight line and the direction information of the corresponding straight line as described above. Likewise, the PSF is generated from the LOR data. Thus, a 3D graph may be converted into a plurality of 2D graphs with respect to each of the projection directions as described above by merely classifying the LOR data according to the direction information.

For example, the parameter calculation unit 43 may classify a signal obtained with respect to a location of a point source according to each of the projection directions, fit a predetermined function to a distribution of the classified signals, and calculate a parameter with respect to the fitted predetermined function.

For example, referring to FIG. 7, the parameter calculation unit 43 may classify LOR data included in the distribution 714 into LOR data having the same direction information of each piece of LOR data. The parameter calculation unit 43 may then generate graphs 731 through 736 using the LOR data classified for each piece of direction information. For example, graph 731 indicates a PSF corresponding to a projection angle of 15 degrees by classifying LOR data having direction information corresponding to that projection angle among LOR data included in the distribution 714. In this regard, a horizontal axis of graph 731 corresponds to distance information of LOR data, and a vertical axis thereof corresponds to the number of detected LOR data or a probability of detecting LOR data.

That is, in the PET, the parameter calculation unit 43 may classify LOR signals obtained by the signal obtaining unit 42 according to projection angles by using direction information of each of the LOR signals. Thus, a process of generating a 3D PSF, projecting the 3D PSF, and generating a 2D graph for each of projection directions may be omitted. Accordingly, a parameter corresponding to each of the LOR signals for each of the projection directions is calculated.

Furthermore, although not described with reference to FIG. 7, a process of fitting specific data to a probability function and calculating a parameter corresponding to the specific data may be used in other examples.

FIG. 8 illustrates two continuous graphs 81 and 82 of parameters calculated by the parameter calculation unit 43 of FIG. 4 with respect to each of the projection directions. With reference to FIGS. 7-8, graphs 81 and 82 of FIG. 8 illustrate Gaussian function parameters for each of the projection directions with respect to an angle of 0 degree from a predetermined straight line that crosses the center of the detector 110 to each of the locations of the point source, and each distance of 2, 10, 20 and 30 from the center of the detector 110 to each of the locations of the point source.

Graph 81 of FIG. 8 illustrates a Gaussian parameter σ_left. Graph 82 of FIG. 8 illustrates a Gaussian parameter σ_right.

Horizontal axes of graphs 81 and 82 indicate projection angles, and vertical axes thereof indicate values of a parameter σ. For example, in graph 81, a line 811 illustrates the Gaussian parameter σ_left for each of the projection directions in an example in which the angle is 0 degree from the predetermined straight line that crosses the center of the detector 110 to a point source, and the location of the point source is at a distance of 30 cm from the center of the detector 110.

Likewise, a line 812 illustrates the Gaussian parameter σ_left for each of projection direction in an example in which the angle is 0 degree from the predetermined straight line that crosses the center of the detector 110 to a location of a point source, and the location of the point source is at a distance of 20 cm from the center of the detector 110. A line 813 illustrates the Gaussian parameter σ_left for each of projection direction in an example in which the angle is 0 degree from the predetermined straight line that crosses the center of the detector 110 to a location of a point source, and the location of the point source is at a distance of 10 cm from the center of the detector 110. A line 814 illustrates the Gaussian parameter σ_left for each of projection direction in an example in which the angle is 0 degree from the predetermined straight line that crosses the center of the detector 110 to a location of a point source, and the location of the point source is at a distance of 2 cm from the center of the detector 110.

For example, in graph 82, a line 821 illustrates the Gaussian parameter σ_right for each of the projection directions in an example in which the angle is 0 degree from the predetermined straight line that crosses the center of the detector 110 to a point source, and the location of the point source is at a distance of 30 cm from the center of the detector 110.

Likewise, a line 822 illustrated in graph 82 shows the Gaussian parameter σ_right for each of projection direction in an example in which the angle is 0 degree from the predetermined straight line that crosses the center of the detector 110 to a location of a point source, and the location of the point source is at a distance of 20 cm from the center of the detector 110. A line 823 illustrated in graph 82 shows the Gaussian parameter σ_right for each of projection direction in an example in which the angle is 0 degree from the predetermined straight line that crosses the center of the detector 110 to a location of a point source, and the location of the point source is at a distance of 10 cm from the center of the detector 110. A line 824 illustrates the Gaussian parameter σ_right for each of projection direction in an example in which the angle is 0 degree from the predetermined straight line that crosses the center of the detector 110 to a location of a point source, and the location of the point source is at a distance of 2 cm from the center of the detector 110.

Graphs 81 and 82 of FIG. 8 illustrate examples in which the angle from the predetermined straight line that crosses the center of the detector 110 to the location of a point source is 0 degree. Thus, the parameter calculation unit 43 calculates parameters used to show graph 81 or 82 according to each angle by changing the angle from the predetermined straight line that crosses the center of the detector 110 to each of the locations of the point source.

Accordingly, the parameters are calculated with respect to projection directions at each location of the point source as well as an angle from the predetermined straight line that crosses the center of the detector 110 to the locations of the point source and the distance of the locations of the point source from the center of the detector 110. That is, a parameter depends on locations of the point source and the projection directions.

Referring to FIG. 4, the blur model generation unit 44 generates a blur model of the detector 110 based on the parameter calculated with respect to each location of the point source in the detector 110 and each projection direction. The blur model generation unit 44 may store the generated blur model in a storage device 500. In one example, the storage device 500 may be implemented as a part of the computer 200 illustrated in FIG. 1. In another example, the storage device 500 may be implemented external to the computer 200.

For example, in the example illustrated in FIG. 6, when the control unit 41 changes a location of the point source within a range that does not exceed the unit area 60, the blur model generation device 40 may generate the blur model of the whole detector 110 by using a signal detected with respect to the unit area 60.

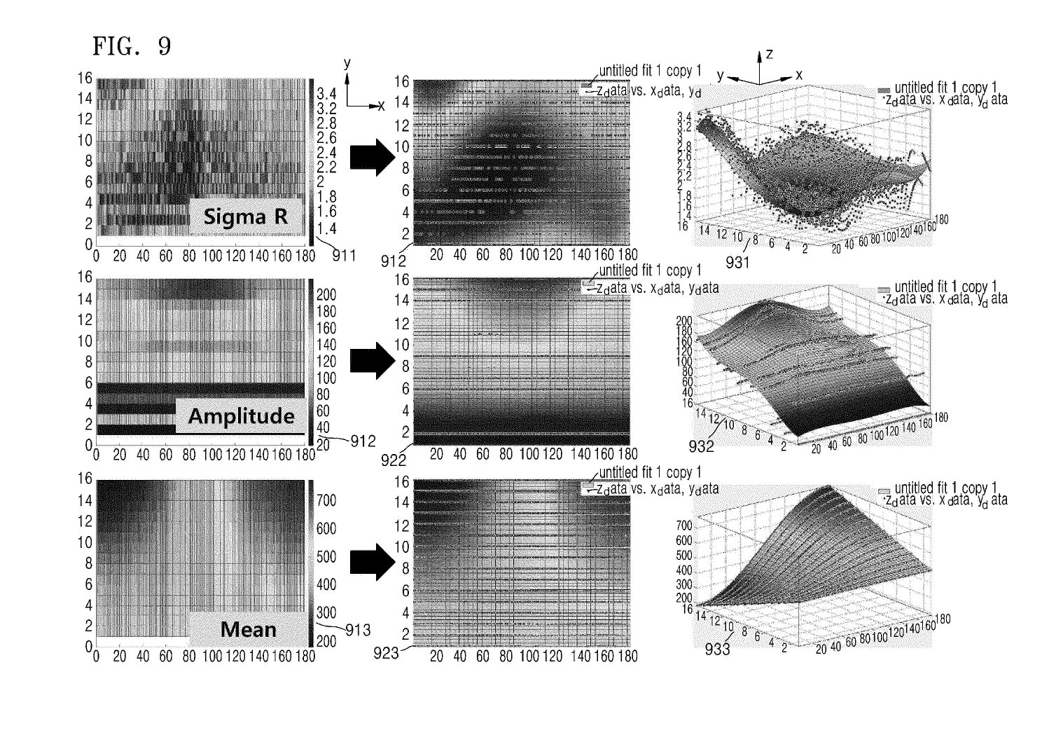

In another example, the blur model generation unit 44 calculates at least one parameter with respect to an inter-location between locations in the detector 110 based on at least one parameter calculated with respect to each location. Then, the blur model generation unit 44 generates the blur model of the detector 110 based on all the calculated parameters. For example, the blur model generation unit 44 may use an interpolation method to calculate at least one parameter with respect to the inter-location between each of the locations of the point source in the detector 110 based on at least one parameter calculated with respect to each of the locations of the point source, and may generate the blur model of the detector 110 based on all the calculated parameters. This example will now be described with reference to FIG. 9 below.

FIG. 9 illustrates an example of generating a blur model of the detector 110 by using parameters calculated by the parameter calculation unit 43 in the blur model generation unit 44.

Referring to FIG. 9, graphs 911, 912, and 913 show parameters fitted to a Gaussian function by projecting a distribution with respect to each location of the point source in each direction while changing a distance from the center of the detector 110 to the location of the point source when an angle from a predetermined straight line that crosses the center of the detector 110 to the location of the point source is 0 degree. Thus, graphs such as graphs 911, 912, and 913 may be generated with respect to the angle from the predetermined straight line that crosses the center of the detector 110 to each of the locations of the point source. In this regard, the projected distribution is determined by the locations of the point source estimated from a signal detected with respect to a location of a point source as described above.

Axes x of graphs 911, 912, and 913 indicate distances from the center of the detector 110 to the locations of the point source, and axes y thereof indicate projection directions. Graphs 911, 912, and 913 use pixel brightness or grayscale to express parameter information corresponding to coordinates.

Graphs 921, 922, and 923 illustrates examples of result obtained from the blur model generation unit 44. The result is obtained from a blur model generation unit 44 that calculates at least one parameter with respect to the inter-location between each of the locations of the point source in the detector 110 based on at least one parameter calculated with respect to each of the locations of the point source, and then generates the blur model of the detector 110 based on all of the calculated parameters.

An interpolation method may be used to calculate at least one parameter with respect to the inter-location between each of the locations of the point source in the detector 110 based on at least one parameter calculated with respect to each of the locations of the point source. The interpolation method is a calculation method of approximating a function value between two or more function values based on the two or more function values. For example, the interpolation method approximates f(n) from f(1) and f(2) (wherein, 1<n<2).

An example of a simple interpolation method that may be used is a linear interpolation method of interpolating between two neighboring points in a simple expression. In addition, a method of determining a polynomial continuous function having two or more expressions fitted to given data and interpolating values between the given data by using a function value of the determined polynomial continuous function may also be used in other examples.

Such an interpolation method using the polynomial continuous function is a method of using limited data and fitting a polynomial continuous function that most matches the limited data. The higher the order of the polynomial continuous function, the more accurate the fitting, in exchange for increase in arithmetic load. Thus, a user may set an appropriate order of a polynomial continuous function in consideration of a trade-off relationship between accurate fitting and an arithmetic load.

Graphs 911, 912, and 913 show examples of the blur model generation unit 44. The blur model generation unit 44 calculates at least one parameter with respect to the inter-location between locations of the point source in the detector 110 based on at least one parameter calculated with respect to each of the locations of the point source by using a five-polynomial function fitting method, and generates the blur model of the detector 110 based on all the calculated parameters.

In another example, a Gaussian mixture modeling method may be used. In this case, the blur model generation unit 44 of FIG. 4 generates the blur model of the detector 110 by determining a Gaussian mixture model function in which a plurality of Gaussian functions that are most appropriate to at least one parameter calculated with respect to each of the locations of the point source in the detector 110 are overlapped.

Furthermore, the blur model generation unit 44 may generate the blur model of the detector 110 by calculating a parameter of a polynomial function or a Gaussian mixture model function fitted to at least one parameter calculated with respect to each of the locations of the point source in the detector 110. The blur model of the detector 110 is parameterized, thereby reducing memory usage necessary for storing the blur model of the detector 110.

Like the graphs 911, 912, and 913, axes x of graphs 921, 922, and 923 indicate distances from the center of the detector 110 to the locations of the point source, and axes y thereof indicate projection directions. Graphs 921, 922, and 923 also use pixel brightness or grayscale to express parameter information corresponding to coordinates. Graphs 921, 922, and 923 show examples of continuous graphs generated by the blur model generation unit 44 that correspond to graphs 911, 912, and 913 having discontinuous pixel values.

Graphs 931, 932, and 933 are 3D graphs whose parameters along the x and y coordinates correspond with the parameters along the x and y coordinates of graphs 921, 922, and 923, respectively. The parameters along the z axes of graphs 931, 932, and 933 correspond with pixel brightness or grayscale of graphs 921, 922, and 923, respectively. Graphs 921, 922, and 923, and graphs 931, 932, and 933 may also be generated with respect to the angle from the predetermined straight line that crosses the center of the detector 110 to each of the locations of the point source.

The blur model generation unit 44 may store the blur model generated by using the above-described method in the storage device 500. The method of generating the blur model of the detector 110 based on a parameter calculated with respect to each location in the detector 110 performed by the blur model generation unit 44 is not limited to the above-described method. In other example, the method may involve omitting measurements of blur information of one location while blur information of another location is symmetrically applied to another location.

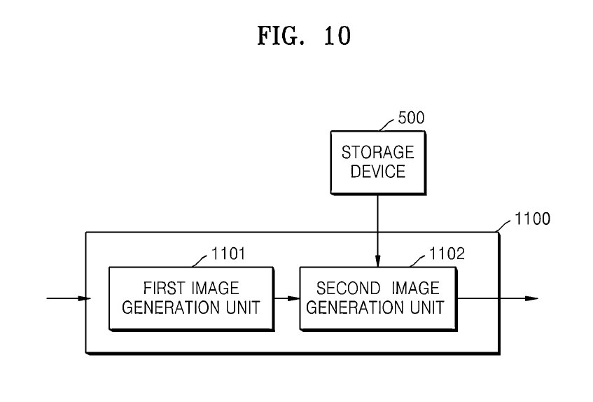

FIG. 10 is a block diagram of components of a computer 200 that may be used to implement a portion of an apparatus for generating an image. The apparatus for generating the image may be used to generate an image of a cross-section of the body of a patient as well as to generate a blur model of a detector 110. The blur model may be used to generate a refined image of the cross-section of the body. The refined image may be a physiological image. In an example in which the apparatus for generating the image of FIG. 1 is used to generate the image of the cross-section of a patient, an image generation unit 1100 illustrated in FIG. 10 may be used to generate the first and second images.

Referring to FIG. 10, the image generation unit 1100 includes a first image generation unit 1101 and a second image generation unit 1102. The first image generation unit 1101 generates a first image of a target by detecting a signal emitted from a tracer injected into the target. The second image generation unit 1102 generates a second image by applying a blur model stored in the storage device 500 to the first image generated by the first image generation unit 1101. The blur model stored in the storage device 500 may be a blur model generated by the blur model generation device 40 of FIG. 4. The blur model may be applied to the first image to improve the resolution of the first image. Thus, the second image may have a higher resolution than the first image.

In an example in which the image generation unit 1100 of FIG. 10 is implemented as the computer 200 illustrated in FIG. 1, the signal detection device 100 of FIG. 1 may detect two gamma rays emitted due to the combination of a positron emitted from a tracer injected into a body of the patient with an electron. The signal detection device 100 transmits LOR data regarding the detected gamma rays to the image generation unit 1100. The first image generation unit 1101 obtains the signal from the signal detection device 100 and generates the first image with respect to the target. The second image generation unit 1102 generates the second image by applying the blur model to the first image generated by the first image generation unit 1101.

In this regard, the first image may be a low resolution blurry image, and the second image may be a high resolution image from which the blurring in the first image is eliminated by applying the blur model of the detector 110.

For example, the second image generation unit 1102 may generate the second image using expectation maximization (EM) algorithm. The EM algorithm is used to precisely approach a high resolution image through a repetitive calculation according to equation 1 below.

$${n}_{j}^{k + 1} = \frac{{n}_{j}^{k}}{{\sum }_{i}^{I} {a}_{ij}} {\sum }_{i}^{I} {a}_{ij} \frac{{m}_{i}}{{q}_{i}^{k}} \qquad 〈 Equation 1 〉$$

In Equation 1 above, j denotes a voxel coordinate indicating a location of a point source in the detector 110, i denotes a type of LOR data, and k denotes a number of repeated algorithms. Accordingly, nⱼ^{k} of Equation 1 denotes a pixel output value with respect to the voxel j in the detector 110, and aᵢⱼ denotes a value indicating a probability of detecting the LOR i when a gamma ray is emitted from the voxel j, and may be calculated from the blur model. mᵢ denotes a number of the detected LOR i, and qᵢ^{k} is calculated from aᵢⱼ and nᵢ^{k} according to Equation 2 below.

$${q}_{i}^{k} = {\sum }_{j}^{J} {a}_{ij} {n}_{j}^{k} \qquad 〈 Equation 2 〉$$

Although not described above, the EM algorithm and the method of applying the blur model to the EM algorithm would be readily understood by one of ordinary skill in the art.

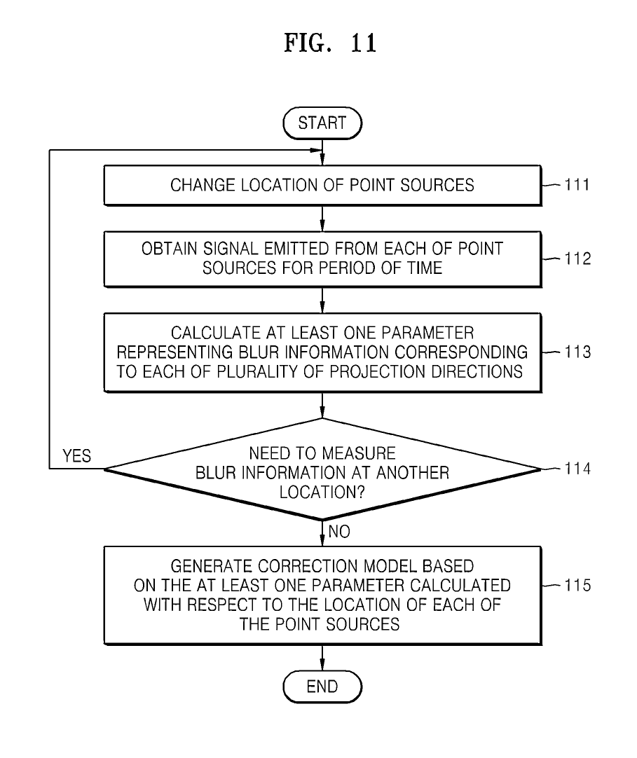

FIG. 11 is a flowchart illustrating an example of a blur model generating method. Referring to FIGS. 4 and 11, in operation 111, the control unit 41 changes a location of each of point sources in the detector 110. To this end, the control unit 41 may control the detector 110 or point sources in the detector 110. In operation 112, the signal obtaining unit 42 obtains a signal emitted from each of point sources for a predetermined period of time. In operation 113, the parameter calculation unit 43 calculates at least one parameter representing blur information corresponding to each of a plurality of projection directions at each location of the point source by using the obtained signal.

For example, in operation 113, the parameter calculation unit 43 generates a PSF indicating a distribution of estimated location of the point source in which the location of the point source is estimated from the signal obtained with respect to each of the locations of the point source and calculates at least one parameter indicating a characteristic of the PSF with respect to each of the projection directions from the generated PSF at each of the locations of the point source.

In operation 114, the blur model generation device 40 determines whether to measure blur information at another location. If the blur model generation device 40 determines that it is necessary to measure the blur information at another location, operation 111 is performed. If the blur model generation device 40 determines that it is not necessary to measure the blur information at another location, operation 115 is performed. In operation 115, the blur model generation unit 44 generates a blur model of the detector 110 based on the at least one parameter calculated with respect to each of the locations of the point source and each of projection directions.

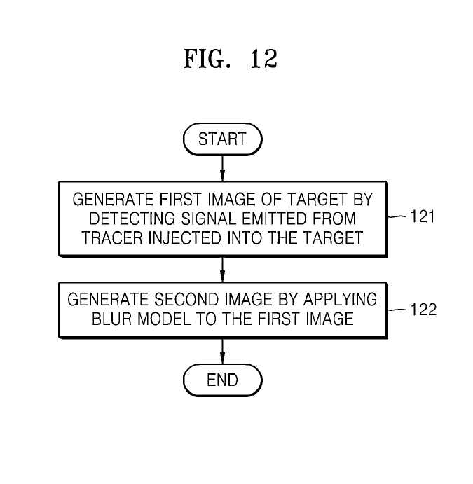

FIG. 12 illustrates an example of an image generating method. Referring to FIGS. 11 and 12, in operation 121, the first image generation unit 1101 generates a first image of a target by detecting a signal emitted from a tracer injected into the target. In operation 122, the second image generation unit 1102 generates a second image by applying a blur model of the detector 110 to the first image generated by the first image generation unit 1101. In this regard, the blur model of FIG. 12 may be the blur model of the detector 110 generated by using the blur model generating method illustrated in FIG. 11.

According to some of the examples described above, a method of generating an image of a target through PET may generate a high resolution image by generating a blur model of the detector 110 and applying the blur model to an image obtained by an image generation device. The blur model may be generated using a method of generating blur information depending on a location of a point source. This method may reduce memory usage of the blur model but it may reduce accuracy.

According to some of the examples described above, the arrangement of detection elements in the detector 110 is not perfectly circular. Thus, the blur information may be generated according to a location of the point source and the projection direction considering that the blur information differs according to each of the projection directions. Thus, a reduction in the accuracy may be resolved, and accordingly, a clear high resolution image may be generated.

According to some of the examples described above, when the blur model is stored, a graph indicating the blur model may not be stored in the storage device 500 but instead be fitted to a predetermined function, and a parameter of the fitted function may be stored therein, thereby greatly reducing memory usage.

Further, the user may preset distances and angles or input another adjustment factor through the user input device 400 when setting locations of a point source. Thus, an image having an image quality desired by the user may be generated in a trade-off relationship between the quality of the image and an arithmetic load (or memory usage) of a processor.

Furthermore, the above-described examples are not limited to PET scanning technologies and may be applied to other image generating devices that obtain a signal through a detector and generate an image.

The blur model generating method of FIG. 11 and the image generating method of FIG. 12 may be written as computer programs and may be implemented in general-use digital computers that execute the programs using a computer readable storage medium. Examples of non-transitory computer readable storage medium include magnetic storage media such as a ROM, floppy disks, hard disks, and the like, and optical recording media such as CD-ROMs, DVDs, and the like.

The units described above may be implemented using either a hardware component or a software component, or both. For example, a unit may include a processing device and memory storage. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements.

As described above, according to the one or more of the above examples, a very accurate correction model may be generated with respect to a PET detector, and a high resolution PET image may be generated by applying the correction model to the image data obtained by such a detector.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating a correction model of a detector, the method comprising:
changing a location of a point source in a detection space of the detector and obtaining a signal emitted from the point source for a period of time with respect to each of the changed locations of the point source;
calculating at least one parameter representing a distribution characteristic of the obtained signal with respect to each of a plurality of projection directions at each of the changed locations of the point source from the obtained signal with respect to each of the changed locations of the point source; and
generating the correction model of the detector based on the at least one parameter calculated with respect to each of the locations of the point source and each of the plurality of projection directions.

2. The method of claim 1, wherein the location of the point source is changed according to a distance from a center of the detector to the point source.

3. The method of claim 1, wherein the location of the point source is changed according to an angle from a line that crosses the center of the detector to the point source.

4. The method of claim 3, wherein the angle is changed within a range that does not exceed an angle as determined from a geometric shape of the detector.

5. The method of claim 1, wherein the calculating comprises:
classifying the obtained signal with respect to each of the changed locations of the point source and with respect to each of the plurality of projection directions; and
fitting a function to a distribution of the classified signals,
wherein the at least one parameter is a parameter of the fitted function.

6. The method of claim 5, wherein the fitted function is a Gaussian function.

7. The method of claim 1, wherein the generating of the correction model comprises:
calculating at least one parameter with respect to inter-locations between each of the changed locations of the point source based on the at least one parameter calculated with respect to each of the locations of the point source and generating the correction model of the detector based on the calculated at least one parameter with respect the inter-locations and each of the locations of point source.

8. The method of claim 1, wherein the generating of the correction model comprises:
generating the correction model of the detector by fitting a function corresponding to the correction model of the detector based on the at least one parameter calculated with respect to each of the locations of the point source and each of the plurality of projection directions.

9. A method of generating an image, the method comprising:
changing a location of the point source in a detection space of a detector and obtaining a signal emitted from the point source for a period of time with respect to each of the changed locations of the point source;
calculating at least one parameter representing a distribution characteristic of the obtained signal with respect to each of a plurality of projection directions at each of the changed locations of the point source from the obtained signal with respect to each of the changed locations of the point source;
generating the correction model of the detector based on the at least one parameter calculated with respect to each of the locations of the point source and each of the plurality of projection directions;
generating a first image based on a signal emitted from a tracer; and
generating a second image by applying the generated correction model to the generated first image.

10. The method of claim 9, wherein the generating of the second image comprises using expectation maximization (EM) algorithm.

11. An apparatus for generating a correction model of a detector, the apparatus comprising:
a signal obtaining unit configured to change a location of a point source in a detection space of the detector and to obtain a signal emitted from the point source for a period of time with respect to each of the changed locations of the point source;
a parameter calculation unit configured to calculate at least one parameter representing a distribution characteristic of the obtained signal with respect to each of a plurality of projection directions at each of the changed locations of the point source from the obtained signal with respect to each of the changed locations of the point source; and
a correction model generation unit configured to generate the correction model of the detector based on the calculated at least one parameter calculated with respect to each of the locations of the point source and each of the plurality of projection directions.

12. The apparatus of claim 11, wherein the location of the point source is changed according to a distance from a center of the detector to the point source.

13. The apparatus of claim 11, wherein the location of the point source is changed according to an angle from a line that crosses the center of the detector to the point source.

14. The apparatus of claim 13, wherein the angle is changed within a range that does not exceed an angle as determined from a geometric shape of the detector.

15. The apparatus of claim 11, further comprising:
a classification unit configured to classify the obtained signal with respect to each of the changed location of the point source for each of the plurality of projection directions; and
a first fitting unit configured to fit a function to a distribution of the classified signals,
wherein the at least one parameter is a parameter of the fitted function.

16. The apparatus of claim 15, wherein the fitted function is a Gaussian function.

17. The apparatus of claim 11, wherein the correction model generation unit is configured to calculate at least one other parameter with respect to inter-locations between each of the changed locations of the point source based on the at least one parameter calculated with respect to each of the locations of the point source and generates the correction model of the detector based on the calculated at least one parameter with respect the inter-locations and each of the locations of the point source.

18. The apparatus of claim 11, wherein the correction model generation unit is configured to generate the correction model of the detector by fitting a function corresponding to the correction model of the detector based on the at least one parameter calculated with respect to each of the locations of the point source and each of the plurality of projection directions.

19. An apparatus for generating an image, the apparatus comprising:
a signal obtaining unit configured to change a location of a point source in a detection space of a detector and to obtain a signal emitted from the point source for a period of time with respect to each of the changed locations of the point source;
a parameter calculation unit configured to calculate at least one parameter representing a distribution characteristic of the obtained signal with respect to each of a plurality of projection directions at each of the changed locations of the point source from the obtained signal with respect to each of the changed locations of the point source;
a correction model generation unit configured to generate the correction model of the detector based on the at least one parameter calculated with respect to each of the locations of the point source and each of the plurality of projection directions;
a first image generation unit configured to generate a first image based on a signal emitted from a tracer; and
a second image generation unit configured to generate a second image by applying the generated correction model to the first image.

20. A non-transitory computer-readable storage medium having stored thereon a program, which when executed by a computer, performs the method of claim 1.
